(19) United States
(12) Patent Application Publication
(10) Pub. No.: US 2025/0209798 A1
(43) Pub. Date: Jun. 26, 2025

(54) TARGET DETECTION MODEL TRAINING METHOD AND APPARATUS, AND ELECTRONIC DEVICE

(71) Applicant: UBTECH ROBOTICS CORP LTD, Shenzhen (CN)

(72) Inventors: PENGYU ZOU, Shenzhen (CN); Shuping Hu, Shenzhen (CN); Kan Wang, Shenzhen (CN); Pei Dong, Shenzhen (CN); Jianxin Pang, shenzhen (CN); Huan Tan, Shenzhen (CN)

(21) Appl. No.: 18/783,390

(22) Filed: Jul. 24, 2024

(30) Foreign Application Priority Data
Dec. 23, 2023 (CN) 202311814508.0

(51) Int. Cl. G06V 10/774; G06N 20/20

(52) U.S. Cl. CPC G06V 10/7753; G06N 20/20

(57) ABSTRACT

A method and an apparatus for training target detection models and an electronic device are provided. The method includes: predicting unlabeled training data through a teacher model and a student model to obtain a first prediction result output by the teacher model and a second prediction result output by the student model; determining a target pseudo-label category to which the first prediction result belongs according to the confidence in the first prediction result; calculating a current pseudo-label loss based on the first prediction result, the second prediction result, and the pseudo-label loss function corresponding to the target pseudo-label category; and updating the student model according to the current pseudo-label loss and updating the teacher model based on the updated student model, and returning to predicting the unlabeled training data through the teacher model and the student model until a preset training end condition is met.

### CROSS REFERENCE TO RELATED APPLICATIONS

The present disclosure claims priority to Chinese Patent Application No. 202311814508.0, filed Dec. 23, 2023, which is hereby incorporated by reference herein as if set forth in its entirety.

### TECHNICAL FIELD

The present disclosure relates to machine learning technology, and particularly to a method and an apparatus for training target detection models and an electronic device.

### BACKGROUND

The main purpose of a semi-supervised target detection method is to perform supervised training on a model using a small amount of labeled data to enable the model to learn unlabeled data through pseudo-label learning or consistency regularization, so that the relevant indicators on the test set can outperform the supervised learning method.

Currently, in the process of a single-stage anchor-based semi-supervised target detection method, many detection boxes will be generated. In this case, the increase in the amount of detection boxes means the decrease in the quality of the detection boxes, resulting in serious consistency problems of pseudo-labels, which may eventually lead to the model being unable to learn useful information from unlabeled images.

### BRIEF DESCRIPTION OF DRAWINGS

To describe the technical schemes in the embodiments of the present disclosure or in the prior art more clearly, the following briefly introduces the drawings required for describing the embodiments or the prior art. It should be understood that, the drawings in the following description merely show some embodiments. For those skilled in the art, other drawings can be obtained according to the drawings without creative efforts.

FIG. 1 is a flow chart of a target detection model training method according to an embodiment of the present disclosure.

FIG. 2 is a schematic diagram of the structure of detection heads before and after decoupling according to an embodiment of the present disclosure.

FIG. 3 is a schematic block diagram of a target detection model training apparatus according to an embodiment of the present disclosure.

FIG. 4 is a schematic diagram of the structure of an electronic device according to an embodiment of the present disclosure.

### DETAILED DESCRIPTION

In the following descriptions, for purposes of explanation instead of limitation, specific details such as particular system architecture and technique are set forth in order to provide a thorough understanding of embodiments of the present disclosure. However, it will be apparent to those skilled in the art that the present disclosure may be implemented in other embodiments that are less specific of these details. In other instances, detailed descriptions of well-known systems, devices, circuits, and methods are omitted so as not to obscure the description of the present disclosure with unnecessary detail.

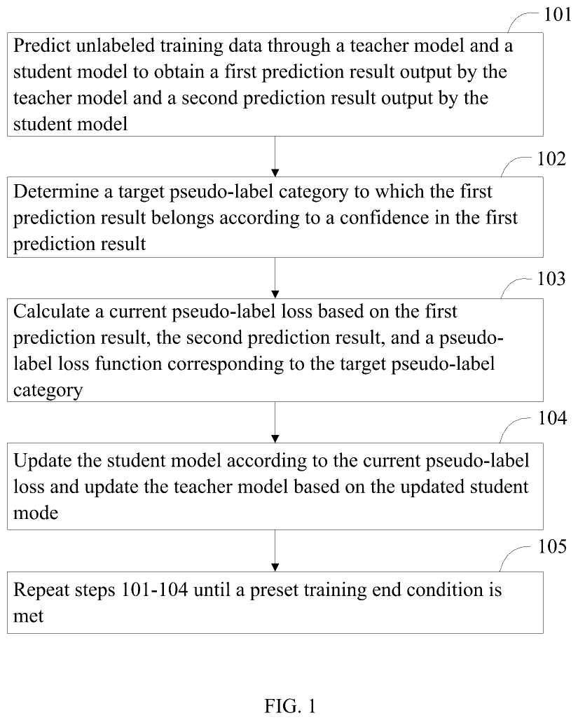

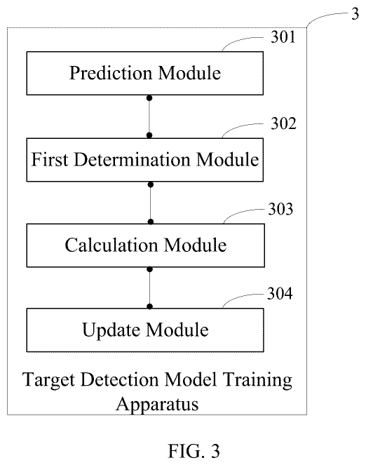

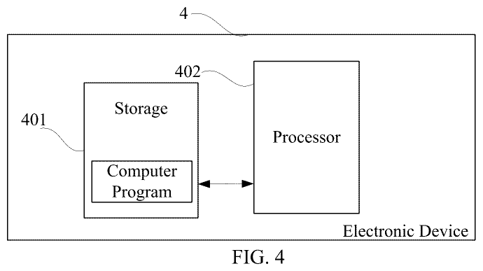

In the embodiments of the present disclosure, a training method for target detection models that may be applied to an electronic device (of FIG. 4) with data processing functions is provided. In some embodiment, the electronic device may be a personal computer, a smart phone, a tablet computer, a robot, or the like. FIG. 1 is a flow chart of a target detection model training method according to an embodiment of the present disclosure. A training method for target detection models may be applied on (a processor of) a target detection model training apparatus (e.g., the electronic device) shown in FIG. 3. In other embodiments, the method may be implemented through the electronic device shown in FIG. 4. As shown in FIG. 1, in this embodiment, the training method for target detection models may include the following steps.
101: predicting unlabeled training data through a teacher model and a student model to obtain a first prediction result output by the teacher model and a second prediction result output by the student model.

The teacher model and the student model are target detection models that have completed preliminary training with a small amount of labeled training data. In which, the teacher model and the student model have the same model structures, and have the same initial model parameter(s), too. That is, the teacher model and the student model can be considered to be exactly the same model in their initial state.

In order to make a more reliable judgment on the prediction results of the teacher model and the student model, detection heads of the teacher model and the student model may be decoupled detection heads. That is, a plurality of tasks of the teacher model and the student model, namely a positioning task, a classification task, and a confidence task may be decoupled. In this manner, each of the teacher model and the student model actually contain three task branches that can output a confidence, a detection box position, and a classification, respectively.

Unlabeled training data refers to training images without labels. The apparatus/electronic device may predict the same unlabeled training data through the teacher model and the student model respectively, thereby obtaining one prediction result output by the teacher model and another prediction result output by the student model. For the convenience of distinction, the prediction result output by the teacher model is denoted as the first prediction result, and the prediction result output by the student model is denoted as the second prediction result.

In some embodiments, in order to allow the student model to learn in a better manner better so that the student model that is finally put into use can have a better detection effect in harsh environments, for each unlabeled training data, the apparatus/electronic device may first enhance the unlabeled training data using a preset first data enhancement method to obtain first training data. Then, the apparatus/electronic device may enhance the first training data in a preset second data enhancement method to obtain second training data. It can be understood that the second training data is obtained by performing further data enhancement on the basis of the first training data, which further increases the detection difficulty for the second training data. That is, if the detection difficulty is sorted from easy to difficult, the sequence will be: original unlabeled training data-first training data-second training data. Finally, the first training data may be input into the teacher model for realizing the prediction of the first training data by the teacher model to obtain the corresponding first prediction result, and the second training data may be input into the student mode for realizing the prediction of the second training data by the student model to obtain the corresponding second prediction result.

In some examples, the first data enhancement method may be mosaic enhancement, and the second data enhancement method may be cutout enhancement (i.e., randomly cutting out a part of an image to fill with pixel value “0”). Alternatively, the first data enhancement method may be the cutout enhancement, and the second data enhancement method may be the mosaic enhancement. Otherwise, the first data enhancement method and the second data enhancement method may also be other data enhancement means, respectively.
102: determining a target pseudo-label category to which the first prediction result belongs according to the confidence in the first prediction result.

As described above, the outputs of the teacher model and the student model both include the confidence, the detection box position, and the classification. In some embodiments, the first prediction result may be used as a pseudo-label of the unlabeled training data to verify the second prediction result output by the student model so to realize semi-supervised training of the student model. In this process, in order to avoid the influence of unreliable pseudo-labels on the student model, different pseudo-label categories are divided according to different confidences in advance. Based on this, the apparatus/electronic device may first determine the pseudo-label category to which the first prediction result specifically belongs, that is, the target pseudo-label category, according to the confidence in the first prediction result.

Specifically, the apparatus/electronic device may provide confidence thresholds in advance. In this manner, during the semi-supervised training, the apparatus/electronic device may judge the classification of pseudo-labels based on the confidence threshold by specifically comparing the confidence in the first prediction result with the preset confidence thresholds to obtain a comparison result; and determining the target pseudo-label category according to the comparison result.
103: calculating a current pseudo-label loss based on the first prediction result, the second prediction result, and a pseudo-label loss function corresponding to the target pseudo-label category.

The first prediction result may be used as the pseudo-label, that is, a reference object for verifying the second prediction result. In order to prevent the student model from learning unreliable pseudo-labels, different pseudo-label categories may correspond to different pseudo-label loss functions. In this manner, when calculating the pseudo-label loss of the second prediction result relative to the pseudo-label (i.e., the first prediction result), a unified loss function is no longer used for calculation, but the target pseudo-label category (i.e., the pseudo-label category to which the first prediction result belongs) is used for calculation, thereby eliminating the influence of unreliable pseudo-labels on the pseudo-label loss.
104: updating the student model according to the current pseudo-label loss and updating the teacher model based on the updated student mode.

The apparatus/electronic device may first update the student model according to the current pseudo-label loss (by backpropagating to obtain the gradient corresponding to the current pseudo-label loss so as to update each of the model parameter(s) of the student model), thereby realizing the training of the student model based on the pseudo-label. Then, the apparatus/electronic device may update the teacher model based on the updated student model, so that the reliability of the first prediction result (i.e., the pseudo-label) subsequently output by the teacher model can be improved. In some embodiments, the model parameter(s) of the updated student model may be assigned to the teacher model directly, thereby updating the teacher model. In other embodiments, in order to avoid that the student model learns the wrong distribution in data and causes a harmful effect on the teacher model, the teacher model may be updated by assigning a smoothed result of the model parameter(s) of the updated student model to the teacher model. For example, the apparatus/electronic device may update the teacher model based on the updated student model by means of exponential moving average (EMA). In other embodiments, other smoothing means may also be used.
105: repeating steps 101-104 until a preset training end condition is met.

The apparatus/electronic device may repeat steps 101-104 for a plurality of times based on different unlabeled training data until the preset training end condition is met, and then stop repeating steps 101-104 to complete the semi-supervised training of the student model. The trained student model may be put into practical application, while the teacher model may be discarded. In some embodiments, the training end condition may be that the number of training rounds of the student model reaches a preset training round threshold, or that the indicators of the training of the student model has not been improved for a long time (e.g., the pseudo-label loss has reached convergence).

In some embodiments, the apparatus/electronic device may initialize the teacher model and the student model as follows.

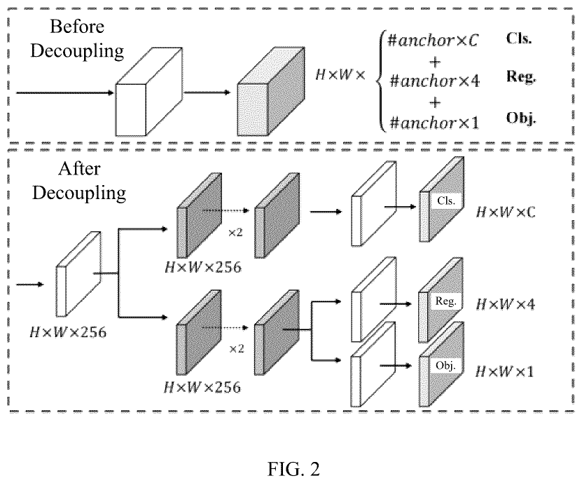

First, an initial target detection model is constructed. In which, the detection head of the target detection model is a decoupled detection head, which is specifically divided into three branches, namely, a confidence branch, a detection box branch, and a classification branch. It can be understood that the confidence branch may be used to output the confidence, the detection box branch may be used to output the detection box position, and the classification branch may be used to output the classification. FIG. 2 is a schematic diagram of the structure of detection heads before and after decoupling according to an embodiment of the present disclosure. As shown in FIG. 2, it can be seen that for the detection head before decoupling, all its detection results are output by one branch; and for the detection head after decoupling, its different detection results are output by corresponding branches respectively. By decoupling the detection head, the target detection model can obtain a more reliable result of the confidence.

Then, a supervised training is performed on the target detection model using labeled training data. In which, the labeled training data refers to training images with labels. Specifically, the loss function used in the supervised training may be represented as an equation of:

$${L}_{s} = \sum ( C E ( {X}^{cls} , {Y}^{cls} ) + C I o U ( {X}^{reg} , {Y}^{reg} ) + C E ( {X}^{obj} , {Y}^{obj} ) ;$$

where, Lₛ is the loss function used in the supervised training; CE represents a cross entropy loss; CIoU represents a complete intersection over union (IoU) loss; and X is a prediction result of the target detection model; Y is the label of the corresponding training image, that is, the value of ground truth; and the superscript cls corresponds to the classification in the prediction result, reg corresponds to the detection box position in the prediction result, and obj corresponds to the confidence in the prediction result.

Finally, the trained target detection model is used as the initial teacher model and student model. It can be understood that the target detection model obtained after the supervised training is a baseline model with basic detection capabilities, which may be used as the initial model used in the semi-supervised training. That is, the teacher model and the student model are both initially the target detection model obtained after the supervised training.

In some embodiments, the apparatus/electronic device may divide pseudo-label categories into the following three categories: a first pseudo-label, a second pseudo-label, and a third pseudo-label. In which, the first pseudo-label has the highest credibility among the three, and the third pseudo-label has the lowest credibility among the three. Usually, the first pseudo-label may be a credible pseudo-label, the second pseudo-label may be an uncertain pseudo-label, and the third pseudo-label may be an incorrect pseudo-label. In this regard, in order to accurately judge the target pseudo-label category to which the first prediction result belongs, the preset confidence threshold may specifically include a first confidence threshold and a second confidence threshold, where the first confidence threshold is larger than the second confidence threshold.

Based on the forgoing settings, when the confidence in the first prediction result is larger than or equal to the first confidence threshold, the apparatus/electronic device may determine that its target pseudo-label category is the first pseudo-label, that is, the first prediction result may be used as the credible pseudo-label. When the confidence in the first prediction result is less than the first confidence threshold and larger than the second confidence threshold, the target pseudo-label category may be determined to be the second pseudo-label, that is, the first prediction result may be used as the uncertain pseudo-label. When the confidence in the first prediction result is less than or equal to the second confidence threshold, the target pseudo-label category is determined to be the third pseudo-label, that is, the first prediction result may be used as the incorrect pseudo-label.

As described above, different pseudo-label categories may correspond to different pseudo-label loss functions. Based on the three categories namely the first pseudo-label, the second pseudo-label, and the third pseudo-label categories, the corresponding pseudo-label loss functions are explained as follows.

It can be understood that, in general, the pseudo-label loss function consists of three parts namely an unlabeled classification loss, an unlabeled detection box loss, and a confidence loss. Specifically, the pseudo-label loss function may be determined by a sum of the unlabeled classification loss, the unlabeled detection box loss, and the confidence loss, and may be represented as an equation of:

$${L}_{u} = {L}_{u}^{cls} + {L}_{u}^{reg} + {L}_{u}^{obj} ;$$

where, Lᵤ is the pseudo-label loss function, Lᵢ^{cls} is the unlabeled classification loss, Lᵤ^{reg} is the unlabeled detection box position loss, and Lᵤ^{obj} is the confidence loss.

As to the first pseudo-label, it may be regarded as a real label, then the corresponding pseudo-label loss function is actually the same as the loss function used in the supervised learning, and the losses may be represented as equations of:

Lᵤ^{cls}=CE(X^{cls},Y_{pseudo}^{cls});

Lᵤ^{reg}=CIoU(X^{reg},Y_{pseudo}^{reg}); and

Lᵤ^{obj}=CE(X^{obj},Y_{pseudo}^{obj});
where, CE represents a cross entropy loss; CIoU represents a complete IoU loss; and X is the second prediction result; Y_{pseudo} is the first prediction result (i.e., the pseudo-label); and the superscript cls corresponds to the classification in the prediction result, reg corresponds to the detection box position in the prediction result, and obj corresponds to the confidence in the prediction result.

That is, let the outputs of the teacher model include a first confidence, a first detection box position, and a first classification, and the outputs of the student model include a second confidence, a second detection box position, and a second classification, then in the pseudo-label loss function corresponding to the first pseudo-label, the detection box loss will be a cross entropy loss of the first detection box position and the second detection box position, the confidence loss will be a cross entropy loss of the first confidence and the second confidence, and the classification loss will be a cross entropy loss of the first classification and the second classification.

As to the second pseudo-label, since it is not as reliable as the first pseudo-label, the student model will not trust its results of the detection box position and the classification. But it is not as unreliable as the third pseudo-label, so the student model will not completely distrust its result of the confidence, and the losses in its corresponding pseudo-label loss function may be represented as equations of:

Lᵤ^{cls}=0;

Lᵤ^{reg}=0; and

Lᵤ^{obj}=CE(X^{obj},obj_{soft});
where, obj_{soft} refers to the use of soft label to calculate the confidence loss (Lᵤ^{obj} is calculated in the manner of soft label). That is, in the pseudo-label loss function corresponding to the second pseudo-label, the detection box loss and the classification loss are 0, and the confidence loss is a soft cross entropy loss of the first confidence and the second confidence.

As to the third pseudo-label, it may be considered completely unreliable. Specifically, for the confidence in the first prediction result, since it is less than the second confidence threshold, the position in image that corresponds to the result of the detection box position should be regarded as the background, that is, there is no object in this position. On this basis, the losses in its corresponding pseudo-label loss function may be represented as equations of:

Lᵤ^{cls}=0;

Lᵤ^{reg}=0; and

Lᵤ^{obj}=CE(X^{obj},0);

That is, in the pseudo-label loss function corresponding to the third pseudo-label, the detection box loss and classification loss are 0, and the confidence loss is a cross entropy loss of the second confidence and 0 (the label of the confidence is set to 0).

On the basis of the above-mentioned different pseudo-label loss functions corresponding to different pseudo-label categories, the credible pseudo-label may be used to instruct the student model to learn on more difficult tasks (i.e., tasks for the second training data). The incorrect pseudo-label will no longer affect the consistency of the pseudo-labels for the semi-supervised learning. The uncertain pseudo-label will reach a balance in the process of calculating the pseudo-label loss by means of soft label, so that the student model can learn certain information from it without fully trusting the uncertain pseudo-label.

As can be seen from the above, in this embodiment, the prediction result output by the teacher model for the unlabeled training data will be used as the pseudo-label of the unlabeled training data, and the training of the student model will be realized based on the pseudo-label. In this process, the method for classifying the pseudo-label according to the confidence of the pseudo-label is provided, and different pseudo-label categories correspond to different pseudo-label loss functions so that each pseudo-label can be processed more reasonably according to the different confidences, thereby improving the consistency of pseudo-labels.

Corresponding to the above-mentioned training method for target detection models, in the embodiments of the present disclosure, a training apparatus 3 for target detection models is further provided. FIG. 3 is a schematic block diagram of a target detection model training apparatus according to an embodiment of the present disclosure. As shown in FIG. 3, the training apparatus 3 may include:
a prediction module 301 configured to predict unlabeled training data through a teacher model and a student model to obtain a first prediction result output by the teacher model and a second prediction result output by the student model, where the teacher model and the student model have a same model structure and initial model parameter, and the first prediction result and the second prediction result both include a confidence, a detection box position, and a classification;
a first determination module 302 configured to determine a target pseudo-label category to which the first prediction result belongs according to the confidence in the first prediction result, where the target pseudo-label category is one of a plurality of pseudo-label categories each corresponding to each pseudo-label loss function;
a calculation module 303 configured to calculate a current pseudo-label loss based on the first prediction result, the second prediction result, and the pseudo-label loss function corresponding to the target pseudo-label category; and
an update module 304 configured to update the student model according to the current pseudo-label loss and update the teacher model based on the updated student model, and trigger the operation of the prediction module again until a preset training end condition is met.

In some embodiments, the training apparatus 3 may further include:
a construction module configured to construct a target detection model, where a detection head of the target detection model is divided into three branches each being for outputting the confidence, the detection box position, and the classification;
a pre-training module configured to perform a supervised training on the target detection model using labeled training data; and
a second determination module configured to use the trained target detection model as the initial teacher model and student model.

In some embodiments, the first determination module 302 may include:
a confidence comparison unit configured to compare the confidence in the first prediction result with preset confidence thresholds to obtain a comparison result;
and

a category determination unit configured to determine the target pseudo-label category according to the comparison result.

In some embodiments, the pseudo-label categories may include a first pseudo-label, a second pseudo-label, and a third pseudo-label with decreasing credibility; the confidence thresholds include a first confidence threshold and a second confidence threshold, and the first confidence threshold is larger than the second confidence threshold; and the category determination unit may include a first determination subunit configured to:
determine that the target pseudo-label category is the first pseudo-label, in response to the confidence in the first prediction result being larger than or equal to the first confidence threshold;
determine that the target pseudo-label category is the second pseudo-label, in response to the confidence in the first prediction result being less than the first confidence threshold and larger than the second confidence threshold; and
determine that the target pseudo-label category is the third pseudo-label, in response to the confidence in the first prediction result being less than or equal to the second confidence threshold.

In some embodiments, the first prediction result output by the teacher model may include a first confidence, a first detection box position, and a first classification, and the second prediction result output by the student model may include a second confidence, a second detection box position, and a second classification; and the pseudo-label loss function may be determined by a sum of a classification loss, a detection box loss, and a confidence loss; where:
in the pseudo-label loss function corresponding to the first pseudo-label, the detection box loss is a cross entropy loss of the first detection box position and the second detection box position, the confidence loss is a cross entropy loss of the first confidence and the second confidence, and the classification loss is a cross entropy loss of the first classification and the second classification;
in the pseudo-label loss function corresponding to the second pseudo-label, the detection box loss and the classification loss are 0, and the confidence loss is a soft cross entropy loss of the first confidence and the second confidence; and
in the pseudo-label loss function corresponding to the third pseudo-label, the detection box loss and the classification loss are 0, and the confidence loss is a cross entropy loss of the second confidence and 0.

In some embodiments, the update module 304 may include:
a teacher model update unit configured to update the teacher model by exponential moving average based on the updated student model.

In some embodiments, the prediction module 301 may include:
a first enhancement processing unit configured to obtain first training data by enhancing the unlabeled training data using a preset first data enhancement method;
a second enhancement processing unit configured to obtain second training data by enhancing the first training data using a preset second data enhancement method;
a first prediction unit configured to obtain the first prediction result by predicting the first training data through the teacher model; and
a second prediction unit configured to obtain the second prediction result by predicting the second training data through the student model.

As can be seen from the above, in this embodiment, the prediction result output by the teacher model for the unlabeled training data will be used as the pseudo-label of the unlabeled training data, and the training of the student model will be realized based on the pseudo-label. In this process, the method for classifying the pseudo-label according to the confidence of the pseudo-label is provided, and different pseudo-label categories correspond to different pseudo-label loss functions so that each pseudo-label can be processed more reasonably according to the different confidences, thereby improving the consistency of pseudo-labels.

Corresponding to the above-mentioned training method for target detection models, the embodiments of the present disclosure further provide an electronic device 4. FIG. 4 is a schematic diagram of the structure of an electronic device according to an embodiment of the present disclosure. As shown in FIG. 4, the electronic device 4 may include a storage 401, one or more processors 402 (only one is shown in FIG. 4) and computer program(s) stored in the storage 401 and executable on the processor 401. In which, the storage 401 is configured to store computer program(s) and unit(s), and the processor 402 executes various functional applications and data processing by executing the computer program(s) stored in the storage 401. Specifically, the processor 402 implements the following steps by executing the above-mentioned computer program(s) stored in the storage 401:
predicting unlabeled training data through a teacher model and a student model to obtain a first prediction result output by the teacher model and a second prediction result output by the student model, where the teacher model and the student model have a same model structure and initial model parameter, and the first prediction result and the second prediction result both include a confidence, a detection box position, and a classification;
determining a target pseudo-label category to which the first prediction result belongs according to the confidence in the first prediction result, where the target pseudo-label category is one of a plurality of pseudo-label categories each corresponding to each pseudo-label loss function;
calculating a current pseudo-label loss based on the first prediction result, the second prediction result, and the pseudo-label loss function corresponding to the target pseudo-label category; and
updating the student model according to the current pseudo-label loss and updating the teacher model based on the updated student model, and returning to predicting the unlabeled training data through the teacher model and the student model until a preset training end condition is met.

Assuming that the forgoing is the first possible implementation, in the second possible implementation provided on the basis of the first possible implementation, the processor 402 may further implement the following steps when executing the above-mentioned computer program(s) stored in the storage 401:
constructing a target detection model, where a detection head of the target detection model is divided into three branches each being for outputting the confidence, the detection box position, and the classification;
performing a supervised training on the target detection model using labeled training data; and
using the trained target detection model as the initial teacher model and initial student model.

In the third possible implementation provided on the basis of the first possible implementation or the second possible implementation, the determining the target pseudo-label category to which the first prediction result belongs according to the confidence in the first prediction result may include:
comparing the confidence in the first prediction result with preset confidence thresholds to obtain a comparison result; and
determining the target pseudo-label category according to the comparison result.

In the fourth possible implementation provided on the basis of the third possible implementation, the pseudo-label categories may include a first pseudo-label, a second pseudo-label, and a third pseudo-label each with a credibility, and the credibility of the first pseudo-label may be larger than the credibility of the second pseudo-label while the credibility of the second pseudo-label may be larger than the credibility of the third pseudo-label; the confidence thresholds may include a first confidence threshold and a second confidence threshold, and the first confidence threshold may be larger than the second confidence threshold. The determining the target pseudo-label category according to the comparison result may include:
determining that the target pseudo-label category is the first pseudo-label, in response to the confidence in the first prediction result being larger than or equal to the first confidence threshold;
determining that the target pseudo-label category is the second pseudo-label, in response to the confidence in the first prediction result being less than the first confidence threshold and larger than the second confidence threshold; and
determining that the target pseudo-label category is the third pseudo-label, in response to the confidence in the first prediction result being less than or equal to the second confidence threshold.

In the fifth possible implementation provided on the basis of the fourth possible implementation, the first prediction result output by the teacher model may include a first confidence, a first detection box position, and a first classification, and the second prediction result output by the student model may include a second confidence, a second detection box position, and a second classification; and the pseudo-label loss function may be determined by a sum of a classification loss, a detection box loss, and a confidence loss. In which:
in the pseudo-label loss function corresponding to the first pseudo-label, the detection box loss is a cross entropy loss of the first detection box position and the second detection box position, the confidence loss is a cross entropy loss of the first confidence and the second confidence, and the classification loss is a cross entropy loss of the first classification and the second classification;
in the pseudo-label loss function corresponding to the second pseudo-label, the detection box loss and the classification loss are 0, and the confidence loss is a soft cross entropy loss of the first confidence and the second confidence; and
in the pseudo-label loss function corresponding to the third pseudo-label, the detection box loss and the classification loss are 0, and the confidence loss is a cross entropy loss of the second confidence and 0.

In the sixth possible implementation provided on the basis of the first possible implementation, the updating the teacher model based on the updated student mode may include:
updating the teacher model by exponential moving average based on the updated student model.

In the seventh possible implementation provided on the basis of the first possible implementation or the second possible implementation, the predicting unlabeled training data through the teacher model and the student model to obtain the first prediction result output by the teacher model and the second prediction result output by the student model may include:
obtaining first training data by enhancing the unlabeled training data using a preset first data enhancement method;
obtaining second training data by enhancing the first training data using a preset second data enhancement method;
obtaining the first prediction result by predicting the first training data through the teacher model; and
obtaining the second prediction result by predicting the second training data through the student model.

It should be comprehended that, in this embodiment, the processor 402 may be a central processing unit (CPU), or be other general purpose processor, a digital signal processor (DSP), an application specific integrated circuit (ASIC), a field-programmable gate array (FPGA), or be other programmable logic device, a discrete gate, a transistor logic device, and a discrete hardware component. The general purpose processor may be a microprocessor, or the processor may also be any conventional processor.

The storage 401 may include read only memory and random access memory to provide instructions and data to the processor 402. All or a portion of the storage 401 may also include a non-volatile random access memory. For example, the storage 401 may also store information of device type.

As can be seen from the above, in this embodiment, the prediction result output by the teacher model for the unlabeled training data will be used as the pseudo-label of the unlabeled training data, and the training of the student model will be realized based on the pseudo-label. In this process, the method for classifying the pseudo-label according to the confidence of the pseudo-label is provided, and different pseudo-label categories correspond to different pseudo-label loss functions so that each pseudo-label can be processed more reasonably according to the different confidences, thereby improving the consistency of pseudo-labels.

Those skilled in the art may clearly understand that, for the convenience and simplicity of description, the division of the above-mentioned functional units and modules is merely an example for illustration. In actual applications, the above-mentioned functions may be allocated to be performed by different functional units according to requirements, that is, the internal structure of the device may be divided into different functional units or modules to complete all or part of the above-mentioned functions. The functional units and modules in the embodiments may be integrated in one processing unit, or each unit may exist alone physically, or two or more units may be integrated in one unit. The above-mentioned integrated unit may be implemented in the form of hardware or in the form of software functional unit. In addition, the specific name of each functional unit and module is merely for the convenience of distinguishing each other and are not intended to limit the scope of protection of the present disclosure. For the specific operation process of the units and modules in the above-mentioned system, reference may be made to the corresponding processes in the above-mentioned method embodiments, and are not described herein.

In the above-mentioned embodiments, the description of each embodiment has its focuses, and the parts which are not described or mentioned in one embodiment may refer to the related descriptions in other embodiments.

Those ordinary skilled in the art may clearly understand that, the exemplificative units and steps described in the embodiments disclosed herein may be implemented through electronic hardware or a combination of external device software and electronic hardware. Whether these functions are implemented through hardware or software depends on the specific application and design constraints of the technical schemes. Those ordinary skilled in the art may implement the described functions in different manners for each particular application, while such implementation should not be considered as beyond the scope of the present disclosure.

In the embodiments provided by the present disclosure, it should be understood that the disclosed apparatus (device) and method may be implemented in other manners. For example, the above-mentioned system embodiment is merely exemplary. For example, the division of the above-mentioned modules or units is merely a logical functional division, and other division manner may be used in actual implementations, that is, multiple units or components may be combined or be integrated into another system, or some of the features may be ignored or not performed. In addition, the shown or discussed mutual coupling may be direct coupling or communication connection, and may also be indirect coupling or communication connection through some interfaces, devices or units, and may also be electrical, mechanical or other forms.

The above-mentioned units described as separate components may or may not be physically separated. The components represented as units may or may not be physical units, that is, may be located in one place or be distributed to multiple network units. Some or all of the units may be selected according to actual needs to achieve the objectives of this embodiment.

When the above-mentioned integrated unit is implemented in the form of a software functional unit and is sold or used as an independent product, the integrated module/unit may be stored in a non-transitory computer readable storage medium. Based on this understanding, all or part of the processes in the above-mentioned method for implementing the above-mentioned embodiments of the present disclosure are implemented, and may also be implemented by instructing relevant hardware through a computer program. The above-mentioned computer program may be stored in a non-transitory computer readable storage medium, which may implement the steps of each of the above-mentioned method embodiments when executed by a processor. In which, the computer program includes computer program codes which may be the form of source codes, object codes, executable files, certain intermediate, and the like. The above-mentioned computer readable storage medium may include any entity or device capable of carrying the computer program codes, a recording medium, a USB flash drive, a portable hard disk, a magnetic disk, an optical disk, a computer-readable memory, a read-only memory (ROM), a random access memory (RAM), electric carrier signals, telecommunication signals and software distribution media. It should be noted that the content contained in the computer readable storage medium may be appropriately increased or decreased according to the requirements of legislation and patent practice in the jurisdiction. For example, in some jurisdictions, according to the legislation and patent practice, a computer readable medium does not include electric carrier signals and telecommunication signals.

The above-mentioned embodiments are merely intended for describing but not for limiting the technical schemes of the present disclosure. Although the present disclosure is described in detail with reference to the above-mentioned embodiments, it should be understood by those skilled in the art that, the technical schemes in each of the above-mentioned embodiments may still be modified, or some of the technical features may be equivalently replaced, while these modifications or replacements do not make the essence of the corresponding technical schemes depart from the spirit and scope of the technical schemes of each of the embodiments of the present disclosure, and should be included within the scope of the present disclosure.

What is claimed is:

1. A method, comprising:
predicting unlabeled training data through a teacher model and a student model to obtain a first prediction result output by the teacher model and a second prediction result output by the student model, wherein the teacher model and the student model have a same model structure and initial model parameter, and the first prediction result and the second prediction result both include a confidence, a detection box position, and a classification;
determining a target pseudo-label category to which the first prediction result belongs according to the confidence in the first prediction result, wherein the target pseudo-label category is one of a plurality of pseudo-label categories each corresponding to each pseudo-label loss function;
calculating a current pseudo-label loss based on the first prediction result, the second prediction result, and the pseudo-label loss function corresponding to the target pseudo-label category; and
updating the student model according to the current pseudo-label loss and updating the teacher model based on the updated student model, and returning to predicting the unlabeled training data through the teacher model and the student model until a preset training end condition is met.

2. The method of claim 1, wherein the teacher model and the student model are target detection models; and before predicting the unlabeled training data through the teacher model and the student model, the method further comprises:
constructing a target detection model, wherein a detection head of the target detection model is divided into three branches each being for outputting the confidence, the detection box position, and the classification;
performing a supervised training on the target detection model using labeled training data; and
using the trained target detection model as the teacher model and student model in an initial state.

3. The method of claim 1, wherein determining the target pseudo-label category to which the first prediction result belongs according to the confidence in the first prediction result comprises:
comparing the confidence in the first prediction result with preset confidence thresholds to obtain a comparison result; and
determining the target pseudo-label category according to the comparison result.

4. The method of claim 3, wherein the pseudo-label categories include a first pseudo-label, a second pseudo-label, and a third pseudo-label each with a credibility, and the credibility of the first pseudo-label is larger than the credibility of the second pseudo-label while the credibility of the second pseudo-label is larger than the credibility of the third pseudo-label; the confidence thresholds include a first confidence threshold and a second confidence threshold, and the first confidence threshold is larger than the second confidence threshold; and determining the target pseudo-label category according to the comparison result comprises:
determining that the target pseudo-label category is the first pseudo-label, in response to the confidence in the first prediction result being larger than or equal to the first confidence threshold;
determining that the target pseudo-label category is the second pseudo-label, in response to the confidence in the first prediction result being less than the first confidence threshold and larger than the second confidence threshold; and
determining that the target pseudo-label category is the third pseudo-label, in response to the confidence in the first prediction result being less than or equal to the second confidence threshold.

5. The method of claim 4, wherein the first prediction result output by the teacher model includes a first confidence, a first detection box position, and a first classification, and the second prediction result output by the student model includes a second confidence, a second detection box position, and a second classification; and the pseudo-label loss function is determined by a sum of a classification loss, a detection box loss, and a confidence loss; wherein:
in the pseudo-label loss function corresponding to the first pseudo-label, the detection box loss is a cross entropy loss of the first detection box position and the second detection box position, the confidence loss is a cross entropy loss of the first confidence and the second confidence, and the classification loss is a cross entropy loss of the first classification and the second classification;
in the pseudo-label loss function corresponding to the second pseudo-label, the detection box loss and the classification loss are 0, and the confidence loss is a soft cross entropy loss of the first confidence and the second confidence; and
in the pseudo-label loss function corresponding to the third pseudo-label, the detection box loss and the classification loss are 0, and the confidence loss is a cross entropy loss of the second confidence and 0.

6. The method of claim 1, wherein updating the teacher model based on the updated student model comprises:
updating the teacher model by exponential moving average based on the updated student model.

7. The method of claim 1, wherein predicting unlabeled training data through the teacher model and the student model to obtain the first prediction result output by the teacher model and the second prediction result output by the student model comprises:
obtaining first training data by enhancing the unlabeled training data using a preset first data enhancement method;
obtaining second training data by enhancing the first training data using a preset second data enhancement method;
obtaining the first prediction result by predicting the first training data through the teacher model; and
obtaining the second prediction result by predicting the second training data through the student model.

8. An electronic device, comprising:
a processor;
a memory coupled to the processor; and
one or more computer programs stored in the memory and executable on the processor;
wherein, the one or more computer programs comprise:
instructions for predicting unlabeled training data through a teacher model and a student model to obtain a first prediction result output by the teacher model and a second prediction result output by the student model, wherein the teacher model and the student model have a same model structure and initial model parameter, and the first prediction result and the second prediction result both include a confidence, a detection box position, and a classification;
instructions for determining a target pseudo-label category to which the first prediction result belongs according to the confidence in the first prediction result, wherein the target pseudo-label category is one of a plurality of pseudo-label categories each corresponding to each pseudo-label loss function;
instructions for calculating a current pseudo-label loss based on the first prediction result, the second prediction result, and the pseudo-label loss function corresponding to the target pseudo-label category; and
instructions for updating the student model according to the current pseudo-label loss and updating the teacher model based on the updated student model, and returning to predicting the unlabeled training data through the teacher model and the student model until a preset training end condition is met.

9. The electronic device of claim 8, wherein the teacher model and the student model are target detection models; and the one or more computer programs further comprise:
instructions for constructing a target detection model, wherein a detection head of the target detection model is divided into three branches each being for outputting the confidence, the detection box position, and the classification;
instructions for performing a supervised training on the target detection model using labeled training data; and
instructions for using the trained target detection model as the teacher model and student model in an initial state.

10. The electronic device of claim 8, wherein the instructions for determining the target pseudo-label category to which the first prediction result belongs according to the confidence in the first prediction result comprise:
instructions for comparing the confidence in the first prediction result with preset confidence thresholds to obtain a comparison result; and
instructions for determining the target pseudo-label category according to the comparison result.

11. The electronic device of claim 10, wherein the pseudo-label categories include a first pseudo-label, a second pseudo-label, and a third pseudo-label each with a credibility, and the credibility of the first pseudo-label is larger than the credibility of the second pseudo-label while the credibility of the second pseudo-label is larger than the credibility of the third pseudo-label; the confidence thresholds include a first confidence threshold and a second confidence threshold, and the first confidence threshold is larger than the second confidence threshold; and the instructions for determining the target pseudo-label category according to the comparison result comprise:
instructions for determining that the target pseudo-label category is the first pseudo-label, in response to the confidence in the first prediction result being larger than or equal to the first confidence threshold;
instructions for determining that the target pseudo-label category is the second pseudo-label, in response to the confidence in the first prediction result being less than the first confidence threshold and larger than the second confidence threshold; and
instructions for determining that the target pseudo-label category is the third pseudo-label, in response to the confidence in the first prediction result being less than or equal to the second confidence threshold.

12. The electronic device of claim 11, wherein the first prediction result output by the teacher model includes a first confidence, a first detection box position, and a first classification, and the second prediction result output by the student model includes a second confidence, a second detection box position, and a second classification; and the pseudo-label loss function is determined by a sum of a classification loss, a detection box loss, and a confidence loss; wherein:
in the pseudo-label loss function corresponding to the first pseudo-label, the detection box loss is a cross entropy loss of the first detection box position and the second detection box position, the confidence loss is a cross entropy loss of the first confidence and the second confidence, and the classification loss is a cross entropy loss of the first classification and the second classification;
in the pseudo-label loss function corresponding to the second pseudo-label, the detection box loss and the classification loss are 0, and the confidence loss is a soft cross entropy loss of the first confidence and the second confidence; and
in the pseudo-label loss function corresponding to the third pseudo-label, the detection box loss and the classification loss are 0, and the confidence loss is a cross entropy loss of the second confidence and 0.

13. The electronic device of claim 8, wherein the instructions for updating the teacher model based on the updated student model comprise:
instructions for updating the teacher model by exponential moving average based on the updated student model.

14. The electronic device of claim 8, wherein the instructions for predicting unlabeled training data through the teacher model and the student model to obtain the first prediction result output by the teacher model and the second prediction result output by the student model comprise:
instructions for obtaining first training data by enhancing the unlabeled training data using a preset first data enhancement method;
instructions for obtaining second training data by enhancing the first training data using a preset second data enhancement method;
instructions for obtaining the first prediction result by predicting the first training data through the teacher model; and
instructions for obtaining the second prediction result by predicting the second training data through the student model.

15. A non-transitory computer-readable storage medium for storing one or more computer programs, wherein the one or more computer programs comprise:
instructions for predicting unlabeled training data through a teacher model and a student model to obtain a first prediction result output by the teacher model and a second prediction result output by the student model, wherein the teacher model and the student model have a same model structure and initial model parameter, and the first prediction result and the second prediction result both include a confidence, a detection box position, and a classification;
instructions for determining a target pseudo-label category to which the first prediction result belongs according to the confidence in the first prediction result, wherein the target pseudo-label category is one of a plurality of pseudo-label categories each corresponding to each pseudo-label loss function;
instructions for calculating a current pseudo-label loss based on the first prediction result, the second prediction result, and the pseudo-label loss function corresponding to the target pseudo-label category; and
instructions for updating the student model according to the current pseudo-label loss and updating the teacher model based on the updated student model, and returning to predicting the unlabeled training data through the teacher model and the student model until a preset training end condition is met.

16. The storage medium of claim 15, wherein the teacher model and the student model are target detection models; and the one or more computer programs further comprise:
instructions for constructing a target detection model, wherein a detection head of the target detection model is divided into three branches each being for outputting the confidence, the detection box position, and the classification;
instructions for performing a supervised training on the target detection model using labeled training data; and
instructions for using the trained target detection model as the teacher model and student model in an initial state.

17. The storage medium of claim 15, wherein the instructions for determining the target pseudo-label category to which the first prediction result belongs according to the confidence in the first prediction result comprise:
instructions for comparing the confidence in the first prediction result with preset confidence thresholds to obtain a comparison result; and
instructions for determining the target pseudo-label category according to the comparison result.

18. The storage medium of claim 17, wherein the pseudo-label categories include a first pseudo-label, a second pseudo-label, and a third pseudo-label each with a credibility, and the credibility of the first pseudo-label is larger than the credibility of the second pseudo-label while the credibility of the second pseudo-label is larger than the credibility of the third pseudo-label; the confidence thresholds include a first confidence threshold and a second confidence threshold, and the first confidence threshold is larger than the second confidence threshold; and the instructions for determining the target pseudo-label category according to the comparison result comprise:
instructions for determining that the target pseudo-label category is the first pseudo-label, in response to the confidence in the first prediction result being larger than or equal to the first confidence threshold;
instructions for determining that the target pseudo-label category is the second pseudo-label, in response to the confidence in the first prediction result being less than the first confidence threshold and larger than the second confidence threshold; and
instructions for determining that the target pseudo-label category is the third pseudo-label, in response to the confidence in the first prediction result being less than or equal to the second confidence threshold.

19. The storage medium of claim 18, wherein the first prediction result output by the teacher model includes a first confidence, a first detection box position, and a first classification, and the second prediction result output by the student model includes a second confidence, a second detection box position, and a second classification; and the pseudo-label loss function is determined by a sum of a classification loss, a detection box loss, and a confidence loss; wherein:
in the pseudo-label loss function corresponding to the first pseudo-label, the detection box loss is a cross entropy loss of the first detection box position and the second detection box position, the confidence loss is a cross entropy loss of the first confidence and the second confidence, and the classification loss is a cross entropy loss of the first classification and the second classification;
in the pseudo-label loss function corresponding to the second pseudo-label, the detection box loss and the classification loss are 0, and the confidence loss is a soft cross entropy loss of the first confidence and the second confidence; and
in the pseudo-label loss function corresponding to the third pseudo-label, the detection box loss and the classification loss are 0, and the confidence loss is a cross entropy loss of the second confidence and 0.

20. The storage medium of claim 15, wherein the instructions for updating the teacher model based on the updated student model comprise:
instructions for updating the teacher model by exponential moving average based on the updated student model.
